(19) United States
(12) Patent Application Publication
(10) Pub. No.: US 2024/0210924 A1
(43) Pub. Date: Jun. 27, 2024

(54) CHARACTERIZATION METHOD BASED ON DEEP REINFORCEMENT LEARNING FOR DISCRETE MANUFACTURING INDUSTRY DATA

(71) Applicant: NANJING UNIVERSITY OF POSTS AND TELECOMMUNICATIONS, Jiangsu (CN)

(72) Inventors: Haigen YANG, Jiangsu (CN); Cong WANG, Jiangsu (CN); Mei WANG, Anhui (CN); Luyang LI, Anhui (CN); Donghuang LIN, Jiangsu (CN); Jixin LIU, Jiangsu (CN); Fanyu ZENG, Jiangsu (CN); Yan GE, Jiangsu (CN)

(73) Assignee: NANJING UNIVERSITY OF POSTS AND TELECOMMUNICATIONS, Jiangsu (CN)

(21) Appl. No.: 18/433,343

(22) Filed: Feb. 5, 2024

Related U.S. Application Data
(63) Continuation of application No. PCT/CN2023/088253, filed on Apr. 14, 2023.

(30) Foreign Application Priority Data
Dec. 22, 2022 (CN) 202211654652.8

(51) Int. Cl. G05B 19/418

(52) U.S. Cl. CPC G05B 19/41865; G05B 2219/33027

(57) ABSTRACT

Disclosed is a characterization method based on deep reinforcement learning for discrete manufacturing industry data. The method includes: collecting discrete manufacturing industry data, and creating a spatio-temporal database; dividing the discrete manufacturing industry data into a discrete feature and a continuous feature, creating a data coupling coding network, converting a coding vector in the coding network into a characterization vector, and creating a data characterization model; quantitatively characterizing discrimination of a data category by means of cluster evaluation indexes; and using weights of cluster evaluation indexes of different dimensions as dynamic rewards, creating a deep reinforcement learning model, and updating a neural network parameter of deep reinforcement learning through characterization of an interactive relation between a model and a discrete manufacturing decision-making analysis system.

### CROSS-REFERENCE TO RELATED APPLICATION

This application is a continuation of international application of PCT application serial no. PCT/CN2023/088253 filed on Apr. 14, 2023, which claims the priority benefit of China application no. 202211654652.8 filed on Dec. 22, 2022. The entirety of each of the above mentioned patent applications is hereby incorporated by reference herein and made a part of this specification.

### TECHNICAL FIELD

The present disclosure relates to a characterization method for data, and particularly relates to a characterization method based on deep reinforcement learning for discrete manufacturing industry data.

### BACKGROUND

Data is heterogeneous, massive, high-dimensional, multi-scale and multi-spatio-temporal in the discrete manufacturing industry. These features make it impossible for a traditional characterization method to effectively process such data. It is common to characterize data by a similarity matrix of data objects. A coupling relation between data can be integrated during similarity learning. For instance, ALGO describes a coupling relation between feature values by computing a conditional probability between the feature values of data. A content optimization system (COS) comprehensively analyzes a coupling relation between features and in the features. A content management system (CMS) puts forward measurement of a distance between data objects on the basis of the COS. A clustering using representative (CURE) algorithm captures a coupling relation between different levels of feature values and features in learning of data characterization, and can be converted into different characterization algorithms according to different task solutions. The characterization method for this category of data is generally suitable for discrete data.

However, in the discrete manufacturing industry, the data is generally mixed data composed of continuous data and discrete data, and characterization methods for the mixed data are mostly obtained through data conversion. For instance, spectralCAT automatically discretizes continuous features, and creates new discrete features through clustering of continuous features and category labels. However, the converted data is used as independent features in a clustering model, and a relation between different categories of data features is ignored. On the basis of discretization of the continuous features, CoupledMC uses similarity to characterize discrete features, but discretization of continuous variables causes information loss. Therefore, a relation between continuous features and discrete features can not be well captured only with a Pearson's correlation coefficient. As the deep learning technology grows, some researchers apply deep learning to the field of discrete industrial manufacturing. However, existing deep learning algorithms can only be used for a static discrete industry manufacturing environment and can hardly adapt to complex and dynamic discrete industry manufacturing problems.

Deep reinforcement learning is an interactive learning method. An agent can deal with the dynamic and complex environmental problems by interacting with the environment, so this method is suitable for solving the discrete industry manufacturing problems. However, positive and negative reward values of the existing deep reinforcement learning algorithms are generally set according to artificial experience. This makes it difficult for data characterization decision-making to provide an optimal solution for a discrete industry manufacturing system.

### SUMMARY

Invention objective: the present disclosure aims to provide a characterization method based on deep reinforcement learning for discrete manufacturing industry data, so as to characterize mixed data that dynamically changes.

Technical solution: the characterization method based on deep reinforcement learning for discrete manufacturing industry data according to the present disclosure includes the following steps:
(1) collecting discrete manufacturing industry data, and creating a spatio-temporal database;
(2) dividing the discrete manufacturing industry data into a discrete feature and a continuous feature, creating a data coupling coding network, converting a coding vector in the data coding network into a characterization vector, and creating a data characterization model;
(3) quantitatively characterizing discrimination of a data category by means of cluster evaluation indexes; and
(4) using weights of cluster evaluation indexes of different dimensions as dynamic rewards, creating a deep reinforcement learning model, and updating a neural network parameter of deep reinforcement learning through characterization of an interactive relation between a model and a discrete manufacturing decision-making analysis system.

Preferably, the discrete manufacturing industry data in step (1) includes real-time workshop device data, advanced planning and scheduling (APS) production scheduling data, product data management (PDM) product data, enterprise resource planning (ERP) purchase-sale-stock data, and manufacturing execution system (MES) production execution data.

Preferably, the creating a data coupling coding network in step (2) includes: creating a correlation matrix r(αᵢ^{x}, νⱼ) between the discrete feature and the continuous feature as follows:

$$r ( {a}_{i}^{x} , {v}_{j} ) = \{ \begin{matrix}{a}_{i}^{x} , & if p ( {a}_{i}^{x} , {v}_{j} ) \geq t \\ λ {a}_{i}^{x} , & in other cases\end{matrix}$$

in the matrix, αᵢ^{x} denotes the continuous feature; νⱼ denotes the discrete feature; λ denotes a proportional coefficient; τ denotes a threshold parameter; ρ(αᵢ^{x}, νⱼ) denotes a joint probability density; and a computation function expression of the joint probability density is as follows:

$$p ( {a}_{i}^{x} , {v}_{j} ) = \frac{1}{N} {\sum }_{k = 1}^{N} \{ {L}_{λ} ( {v}_{j}^{k} , {v}_{j} ) W ( \frac{{a}_{i}^{k} - {a}_{i}^{x}}{{h}_{i}} ) \}$$

in the formula, N denotes the number of data objects, L_{λ}(νⱼ^{k}, νⱼ) denotes a kernel function between discrete feature values νⱼ^{k} and νⱼ,

$$W ( \frac{{a}_{i}^{k} - {a}_{i}^{x}}{{h}_{i}} )$$

denotes a kernel function of the continuous feature, αᵢ^{k} denotes a continuous feature value ƒᵢ of a variable Aᵢ on a kth data object, αᵢ^{x} denotes a continuous feature value ƒᵢ of a variable Aᵢ on an xth data object, and rᵢ denotes a bandwidth parameter of the continuous feature; and an expression of the kernel function L_{λ}(νⱼ^{k}, νⱼ) is as follows:

$${L}_{λ} ( {v}_{j}^{k} , {v}_{j} ) = \{ \begin{matrix}1 if {v}_{j}^{k} = {v}_{j} \\ λ in other cases\end{matrix}$$

in the formula, νⱼ^{k} denotes a feature value corresponding to the discrete feature νⱼ on the kth data object, and A denotes a proportional coefficient; and
using the correlation matrix as a data coupling coding vector as follows:

$${M}_{x} = \vert \begin{matrix}r ( {a}_{1}^{n} , {v}_{1} ) & … & r ( {a}_{1}^{n} , {v}_{L} ) \\ ⋮ & ⋱ & ⋮ \\ r ( {a}_{{d}_{n}}^{n} , {v}_{1} ) & … & r ( {a}_{{d}_{n}}^{n} , {v}_{L} )\end{matrix} \vert$$

in the formula, a coupling coding matrix Mₓ denotes a heterogeneous coupling relation between the discrete feature and the continuous feature, and the coupling coding matrix Mₓ is quantitatively converted into a coding vector ƒ.

Preferably, the converting a coding vector in the data coding network into a characterization vector in step (2) includes: converting the coding vector ƒ into the characterization vector with a fully-connected network as follows:

$$h = σ ( f , W )$$

In the formula, σ denotes a logistic function,

$$σ ( z ) = \frac{1}{1 + {e}^{- z}} ,$$

and W∈R includes interaction strengths between all features.

Preferably, the deep reinforcement learning model in step (4) is a deep Q-network (DQN), and a Q-router is characterized as:

$${Q}^{′} ( s , a ) = Q ( s , a ) + λ \{ R - Q ( s , a ) \}$$

In the formula, Q(s, α) denotes a Q value of node s for executing action α. Q denotes creation of a Q routing table, s denotes a model node, α denotes a state action, λ denotes a learning rate, R denotes reward information, Q′(s, α) denotes an updated Q value, and Q(s, α) denotes a Q value before updating.

Preferably, the reward information of deep reinforcement learning in step (4) is a dynamic reward as follows:

$$R = {\sum }_{i = 1}^{n} {α}_{i} {r}_{i}$$

In the formula, rᵢ denotes the cluster evaluation indexes of different dimensions, αᵢ denotes a weight coefficient of the cluster evaluation indexes of different dimensions, and R denotes dynamic reward information.

Preferably, the cluster evaluation indexes of different dimensions include a Calinski-Harabasz (CH) index, a Davies-Bouldin index (DBI), and/or a silhouette coefficient.

Preferably, the deep reinforcement learning model in step (4) further includes one of deep deterministic policy gradient (DDPG), Advanced-Actor-Critic (A2C)/Asynchronous-Advanced-Actor-Critic (A3C), proximal policy optimization (PPO)/trust region policy optimization (TRPO), soft actor critic (SAC), and twin delayed deep deterministic policy gradient (TD3).

Beneficial effects: compared with the prior art, the present disclosure has the following obvious advantages: the mixed data can be characterized, data that dynamically changes can be characterized, characterization enhancement is conducted on industrial big data of a discrete manufacturing industry on the basis of deep reinforcement learning, a dynamic reward form is used, interaction with a discrete industry system is conducted by means of the cluster evaluation indexes, and the dynamic reward information is continuously fed back, such that a data characterization dimension is optimized to the greatest extent, and further an optimal data characterization form is obtained.

### BRIEF DESCRIPTION OF THE DRAWINGS

FIG. 1 is a flow diagram of a characterization method of the present disclosure.

FIG. 2 is a structural diagram of deep reinforcement learning of the present disclosure.

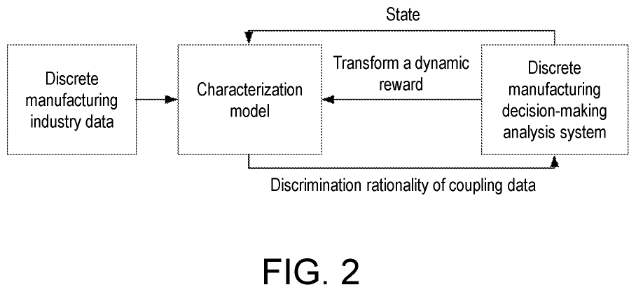

### DETAILED DESCRIPTION OF THE EMBODIMENTS

A technical solution of the present disclosure will be further described below with reference to the accompanying drawings.

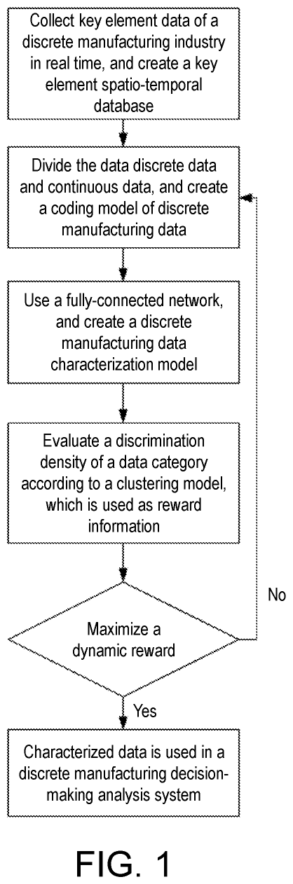

As shown in FIG. 1, a characterization method based on deep reinforcement learning for discrete manufacturing industry data according to the present disclosure includes the following steps:

(1) Discrete manufacturing industry data is collected, and a spatio-temporal database is created.

The discrete manufacturing industry data collected includes real-time workshop device data, advanced planning and scheduling (APS) production scheduling data, product data management (PDM) product data, enterprise resource planning (ERP) purchase-sale-stock data, and manufacturing execution system (MES) production execution data.

(2) The discrete manufacturing industry data is divided into a discrete feature and a continuous feature, a data coupling coding network is created, a coding vector in the data coding network is converted into a characterization vector, and a data characterization model is created. The step specifically includes the following steps:

(2.1) A correlation matrix r(αᵢ^{x}, νⱼ) between the discrete feature and the continuous feature is created as follows:

$$r ( {a}_{i}^{x} , {v}_{j} ) = \{ \begin{matrix}{a}_{i}^{x} , if p ( {a}_{i}^{x} , {v}_{j} ) \geq t \\ λ {a}_{i}^{x} , in other cases\end{matrix}$$

In the matrix, αᵢ^{x} denotes the continuous feature; νⱼ denotes the discrete feature; λ denotes a proportional coefficient; τ denotes a threshold parameter; ρ(αᵢ^{x}, νⱼ) denotes a joint probability density; and a computation function expression of the joint probability density is as follows:

$$p ( {a}_{i}^{x} , {v}_{j} ) = \frac{1}{N} {\sum }_{k = 1}^{N} \{ {L}_{λ} ( {v}_{j}^{k} , {v}_{j} ) W ( \frac{{a}_{i}^{k} - {a}_{i}^{x}}{{h}_{i}} ) \}$$

In the formula, N denotes the number of data objects, L_{λ}(νⱼ^{k}, νⱼ) denotes a kernel function between discrete feature values νⱼ^{k} and νⱼ,

$$W ( \frac{{a}_{i}^{k} - {a}_{i}^{x}}{{h}_{i}} )$$

denotes a kernel function of the continuous feature, αᵢ^{k} denotes a continuous feature value ƒᵢ of a variable Aᵢ on a kth data object, αᵢ^{x} denotes a continuous feature value ƒᵢ of a variable αᵢ on an xth data object, and rᵢ denotes a bandwidth parameter of the continuous feature. An expression of the kernel function L_{λ}(νⱼ^{k}, νⱼ) is as follows:

$${L}_{λ} ( {v}_{j}^{k} , {v}_{j} ) = \{ \begin{matrix}1 if {v}_{j}^{k} = {v}_{j} \\ λ in other cases\end{matrix}$$

In the formula, νⱼ^{k} denotes a feature value corresponding to the discrete feature νⱼ on the kth data object, and λ denotes a proportional coefficient.

(2.2) The correlation matrix is used as a data coupling coding vector as follows:

$${M}_{x} = \vert \begin{matrix}r ( {a}_{1}^{n} , {v}_{1} ) & … & r ( {a}_{1}^{n} , {v}_{L} ) \\ ⋮ & ⋱ & ⋮ \\ r ( {a}_{{d}_{n}}^{n} , {v}_{1} ) & … & r ( {a}_{{d}_{n}}^{n} , {v}_{L} )\end{matrix} \vert$$

In the formula, a coupling coding matrix Mₓ denotes a heterogeneous coupling relation between the discrete feature and the continuous feature, and the coupling coding matrix Mₓ is quantitatively converted into a coding vector ƒ.

(2.3) The coding vector is converted into the characterization vector with a fully-connected network as follows:

$$h = σ ( f , W )$$

In the formula, σ denotes a logistic function,

$$σ ( z ) = \frac{1}{1 + {e}^{- x}} ,$$

and W∈R includes interaction strengths between all features.

(3) Cluster evaluation indexes of different dimensions are selected to quantitatively characterize discrimination of a data category according to needs of a specific scene, where the cluster evaluation indexes include a Calinski-Harabasz (CH) index, a Davies-Bouldin index (DBI), and/or a silhouette coefficient.

The CH index is as follows:

$$CH = \frac{{\sum }_{i} {n}_{i} {d}^{2} ( {c}_{i} , c ) / ( NC - 1 )}{{\sum }_{i} {\sum }_{x ∈ {C}_{i}} {d}^{2} ( x , {c}_{i} ) / ( NC - 1 )}$$

In the formula, cᵢ denotes an i category, ηᵢ denotes the number of data objects in cᵢ, and d(x,y) denotes a distance between data objects x and y.

The DBI is as follows:

$$DBI = \frac{1}{N} {\sum }_{i = 1}^{N} {max}_{j ≢ i} \frac{\overline{{s}_{i}} - \overline{{s}_{j}}}{{‖ {w}_{i} - {w}_{j} ‖}_{2}}$$

In the formula, S̅ᵢ denotes an average Euclidean distance from the ith category of data to a center of the category, and ∥wᵢ−wⱼ∥₂ denotes a Euclidean distance between the ith category and a center of a jth category.

The silhouette coefficient is as follows:

$$S ( i ) = \frac{b ( i ) - a ( i )}{max \{ a ( i ) , b ( i ) \}}$$

In the formula, i and j denote sample points in different categories, and α(i) denotes cohesion of the sample point, that is, similarity between the sample point and other points in the same cluster, which is computed as follows:

$$a ( i ) = \frac{1}{n - 1} {\sum }_{j \neq i}^{n} distance ( i , j )$$

In the formula, distance denotes a distance between i and j; and b(i) denotes similarity between the sample point and other points in a next nearest cluster, which is computed in a similar way to α(i).

(4) According to needs of different scenes, the cluster evaluation indexes of different dimensions are adjusted according to weight coefficients and weighted as dynamic rewards, a deep reinforcement learning model is created, and a neural network parameter of deep reinforcement learning is updated through characterization of an interactive relation between a model and a discrete manufacturing decision-making analysis system.

A deep Q-network (DQN) is used as the deep reinforcement learning model, and a Q-router is characterized as:

$${Q}^{′} ( s , a ) = Q ( s , a ) + λ \{ R - Q ( s , a ) \}$$

In the formula, Q(s, α) denotes a Q value of node s for executing action α. Q denotes creation of a Q routing table, s denotes a model node, α denotes a state action, λ denotes a learning rate, R denotes reward information, Q′(s, α) denotes an updated Q value, and Q(s, α) denotes a value before updating. The dynamic reward information R is as follows:

$$R = {\sum }_{i = 1}^{n} {α}_{i} {r}_{i}$$

In the formula, αᵢ denotes a parameter, and rᵢ denotes the cluster evaluation indexes of different dimensions. If the dynamic reward is maximized, the characterized data is used in the discrete manufacturing decision-making analysis system. Otherwise, step (2) is returned, and a data characterization dimension is optimized to the greatest extent by continuously feeding back the dynamic reward information, such that an optimal data characterization form is obtained. The deep reinforcement learning model in step (4) of the present disclosure is not limited to DQN, and may further be a model of deterministic policy gradient (DDPG), Advanced-Actor-Critic (A2C)/Asynchronous-Advanced-Actor-Critic (A3C), proximal policy optimization (PPO)/trust region policy optimization (TRPO), soft actor critic (SAC), and twin delayed deep deterministic policy gradient (TD3).

What is claimed is:

1. A characterization method based on deep reinforcement learning for discrete manufacturing industry data, comprising following steps:
(1) collecting discrete manufacturing industry data, and creating a spatio-temporal database;
(2) dividing the discrete manufacturing industry data into a discrete feature and a continuous feature, creating a data coupling coding network, converting a coding vector in the data coding network into a characterization vector, and creating a data characterization model;
(3) quantitatively characterizing a discrimination of a data category by means of cluster evaluation indexes; and
(4) using weights of the cluster evaluation indexes of different dimensions as dynamic rewards, creating a deep reinforcement learning model, and updating a neural network parameter of deep reinforcement learning through characterization of an interactive relation between a model and a discrete manufacturing decision-making analysis system.

2. The characterization method according to claim 1, wherein the discrete manufacturing industry data in step (1) comprises real-time workshop device data, advanced planning and scheduling (APS) production scheduling data, product data management (PDM) product data, enterprise resource planning (ERP) purchase-sale-stock data, and manufacturing execution system (MES) production execution data.

3. The characterization method according to claim 1, wherein creating the data coupling coding network in step (2) comprises: creating a correlation matrix r(ax, vi) between the discrete feature and the continuous feature as follows:
$$r ( {a}_{i}^{x} , {v}_{j} ) = \{ \begin{matrix}{a}_{i}^{x} , & if p ( {a}_{i}^{x} , {v}_{j} ) \geq t \\ λ {a}_{i}^{x} , & in other cases\end{matrix}$$
wherein, αᵢ^{x} denotes the continuous feature; νⱼ denotes the discrete feature; λ denotes a proportional coefficient; τ denotes a threshold parameter; ρ(αᵢ^{x}, νⱼ) denotes a joint probability density; and a computation function expression of the joint probability density is as follows:
$$p ( {a}_{i}^{x} , {v}_{j} ) = \frac{1}{N} {\sum }_{k = 1}^{N} \{ {L}_{λ} ( {v}_{j}^{k} , {v}_{j} ) W ( \frac{{a}_{i}^{k} - {a}_{i}^{x}}{{h}_{i}} ) \}$$
in above formula, N denotes a number of data objects, L_{λ}(νⱼ^{k}, νⱼ) denotes a kernel function between discrete feature values νⱼ^{k} and νⱼ,
$$W ( \frac{{a}_{i}^{k} - {a}_{i}^{x}}{{h}_{i}} )$$
denotes a kernel function of the continuous feature, αᵢ^{k} denotes a continuous feature value ƒᵢ of a variable Aᵢ on a kth data object, αᵢ^{k} denotes the continuous feature value ƒᵢ of the variable Aᵢ on an xth data object, and rᵢ denotes a bandwidth parameter of the continuous feature; and an expression of the kernel function L_{λ}(νⱼ^{k}, νⱼ) is as follows:
$${L}_{λ} ( {v}_{j}^{k} , {v}_{j} ) = \{ \begin{matrix}1 & if {v}_{j}^{k} = {v}_{j} \\ λ & in other cases\end{matrix}$$
in above formula, νⱼ^{k} denotes a feature value corresponding to the discrete feature νⱼ on the kth data object, and λ denotes the proportional coefficient; and
using the correlation matrix as a data coupling coding vector as follows:
$${M}_{x} = \vert \begin{matrix}r ( {a}_{1}^{n} , {v}_{1} ) & … & r ( {a}_{1}^{n} , {v}_{1} ) \\ ⋮ & ⋱ & ⋮ \\ r ( {a}_{{d}_{n}}^{n} , {v}_{1} ) & … & r ( {a}_{{d}_{n}}^{n} , {v}_{1} )\end{matrix} \vert$$
a coupling coding matrix Mₓ denotes a heterogeneous coupling relation between the discrete feature and the continuous feature, and the coupling coding matrix Mₓ is quantitatively converted into the coding vector ƒ.

4. The characterization method according to claim 3, wherein converting the coding vector in the data coding network into the characterization vector in step (2) comprises: converting the coding vector ƒ into the characterization vector with a fully-connected network as follows:
$$h = σ ( f , W )$$
in above formula, σ denotes a logistic function,
$$σ ( z ) = \frac{1}{1 + {e}^{- z}} ,$$
W denotes a weight matrix, W∈R, and R denotes a real matrix, which comprises interaction strengths between all features.

5. The characterization method according to claim 1, wherein the deep reinforcement learning model in step (4) is a deep Q-network (DQN), and a Q-router is characterized as:
$${Q}^{′} ( s , a ) = Q ( s , a ) + λ \{ R - Q ( s , a ) \}$$
wherein, Q(s, α) denotes a Q value of node s for executing an action α, wherein Q denotes creation of a Q routing table, s denotes a model node, α denotes a state action, λ denotes a learning rate, R denotes reward information, Q′(s, α) denotes an updated Q value, and Q(s, α) denotes a Q value before updating.

6. The characterization method according to claim 5, wherein the reward information of the deep reinforcement learning in step (4) is a dynamic reward as follows:
$$R = {\sum }_{i = 1}^{n} {α}_{i} {r}_{i}$$
wherein, rᵢ denotes the cluster evaluation indexes of the different dimensions, αᵢ denotes a weight coefficient of the cluster evaluation indexes of the different dimensions, and R denotes the reward information.

7. The characterization method according to claim 6, wherein the cluster evaluation indexes of the different dimensions comprise a Calinski-Harabasz (CH) index, a Davies-Bouldin index (DBI), and/or a silhouette coefficient.

8. The characterization method according to claim 1, wherein the deep reinforcement learning model in step (4) further comprises one of deep deterministic policy gradient (DDPG), Advanced-Actor-Critic (A2C)/Asynchronous-Advanced-Actor-Critic (A3C), proximal policy optimization (PPO)/trust region policy optimization (TRPO), soft actor critic (SAC), and twin delayed deep deterministic policy gradient (TD3).
